(19) United States
(12) Patent Application Publication
(10) Pub. No.: US 2015/0185835 A1
(43) Pub. Date: Jul. 2, 2015

(54) EYE TRACKING METHOD AND APPARATUS

(71) Applicant: Huawei Technologies Co., Ltd., Shenzhen (CN)

(72) Inventors: Xiaojuan MA, Hong Kong (CN); Wing Ki LEUNG, Hong Kong (CN); Ching Man AU YEUNG, Hong Kong (CN)

(73) Assignee: HUAWEI TECHNOLOGIES CO., LTD., Shenzhen (CN)

(21) Appl. No.: 14/575,144

(22) Filed: Dec. 18, 2014

(30) Foreign Application Priority Data
Dec. 28, 2013 (CN) 201310740515.0

(51) Int. Cl. G06F 3/01; G06K 9/00

(52) U.S. Cl. CPC G06F 3/013; G06K 9/0061

(57) ABSTRACT

Embodiments of the present invention disclose an eye tracking method and apparatus, where the method includes: acquiring eye movement information and terminal status information; matching a preset eye tracking scenario by using the acquired eye movement information and terminal status information; and performing, in the matched preset eye tracking scenario, an operation corresponding to the eye movement information. By using the embodiments of the present invention, eye tracking may be performed according to the eye movement information and the terminal status information, which increases the number of eye tracking dimensions, and improves precision of eye tracking and efficiency of eye movement-based interaction.

### CROSS-REFERENCE TO RELATED APPLICATIONS

This application claims priority to Chinese Patent Application No. 201310740515.0, filed on Dec. 28, 2013, which is hereby incorporated by reference in its entirety.

### TECHNICAL FIELD

The present invention relates to the computer field, and in particular, to an eye tracking method and apparatus.

### BACKGROUND

Eye tracking (eye tracking) refers to tracking of movements of eyeballs by measuring a location of a fixation point of eyes or the movements of eyeballs relative to a head. For a mobile terminal such as a smartphone, a smart watch, or a tablet computer, a user implements control and operations on the mobile terminal mainly by performing physical operations, such as touch, drag, and shake, on the mobile terminal. For example, the user may unlock the mobile terminal by inputting a password or inputting an unlock pattern, and then access a login page, and the like.

In the prior art, eye movement data of the user may be acquired, so as to perform the eye tracking; a key point is determined by means of the eye tracking, and a corresponding operation on the mobile terminal is performed. When eye tracking calibration is performed, it may be implemented by the user by locating at least one key point in a preset interface by using a line of sight, for example, unlock information such as a number or a pattern selected by the user in an unlock interface may be determined by acquiring an eye movement input of the user, so as to perform unlocking When eye tracking needs to be calibrated, the calibration may be performed by locating multiple key points in a display interface by using a line of sight. However, in the prior art, regardless of the status of the user and the mobile terminal, the eye tracking is performed only according to the acquired eye movement data of the user, and by adopting a same eye tracking calibration model. However, an operation performed by the user on the mobile terminal and an environment in which the mobile terminal is located change in real time. As a result, the eye tracking calibration is not precise and the number of eye tracking dimensions is singular, which reduces precision of the eye tracking, and reduces efficiency of eye movement-based interaction.

### SUMMARY

Embodiments of the present invention provide an eye tracking method and apparatus, which are used to resolve a technical problem in the prior art that the number of eye tracking dimensions is singular and eye tracking is imprecise.

A first aspect of an embodiment of the present invention provides an eye tracking method, and the method includes:

acquiring eye movement information and terminal status information;

matching a preset eye tracking scenario by using the acquired eye movement information and terminal status information; and

performing, in the matched preset eye tracking scenario, an operation corresponding to the eye movement information.

In a first possible implementation manner of the first aspect, the terminal status information includes: environmental status information and terminal usage status information;

the environmental status information includes: light information, angular acceleration information, location information, or acceleration information; and

the terminal usage status information includes: holding status information, communication information, user operation information, or application process information.

With reference to the first aspect or the first possible implementation manner of the first aspect, in a second possible implementation manner of the first aspect, the acquiring eye movement information and terminal status information includes:

acquiring eye tracking calibration data when a login unlock interface is displayed, and acquiring the eye movement information according to the eye tracking calibration data; and

the performing, in the matched preset eye tracking scenario, an operation corresponding to the eye movement information includes:

generating unlock information according to the matched preset eye tracking scenario and the eye movement information; and

determining, if it is detected that the generated unlock information is consistent with preset unlock information, that unlock is successful.

With reference to the second possible implementation manner of the first aspect, in a third possible implementation manner of the first aspect, after the performing, in the matched preset eye tracking scenario, an operation corresponding to the eye movement information, the method further includes:

updating the eye tracking calibration data according to the acquired eye movement information and terminal status information.

With reference to the third possible implementation manner of the first aspect, in a fourth possible implementation manner of the first aspect, the updating the eye tracking calibration data according to the acquired eye movement information and terminal status information includes:

acquiring historical login data that is closest to the time when the login unlock interface is displayed, where the historical login data includes historical eye movement information and historical terminal status information;

determining whether the acquired eye movement information and terminal status information satisfy a change threshold of the historical login data;

if the acquired eye movement information and terminal status information satisfy the change threshold of the historical login data, updating the eye tracking calibration data according to the acquired eye movement information and terminal status information; and

if the acquired eye movement information and terminal status information do not satisfy the change threshold of the historical login data, acquiring, from all eye tracking calibration data corresponding to the historical login data, eye tracking calibration data that matches the eye movement information and the terminal status information.

With reference to the first aspect and any one of the first to the fourth possible implementation manners of the first aspect, in a fifth possible implementation manner of the first aspect, the operation that corresponds to the eye movement information and is performed in the matched preset eye tracking scenario includes: inputting unlock information, selecting an element on a display page, or operating an application program.

A second aspect of an embodiment of the present invention provides an eye tracking apparatus, and the apparatus includes:

an acquiring module, configured to acquire eye movement information and terminal status information;

a matching module, configured to match a preset eye tracking scenario by using the eye movement information and the terminal status information that are acquired by the acquiring module; and

an executing module, configured to perform, in the matched preset eye tracking scenario, an operation corresponding to the eye movement information.

In a first possible implementation manner of the second aspect, the terminal status information includes: environmental status information and terminal usage status information;

the environmental status information includes: light information, angular acceleration information, location information, or acceleration information; and

the terminal usage status information includes: holding status information, communication information, user operation information, or application process information. With reference to the second aspect or the first possible implementation manner of the second aspect, in a second possible implementation manner of the second aspect, the acquiring module is specifically configured to:

acquire eye tracking calibration data when a login unlock interface is displayed, and acquire the eye movement information according to the eye tracking calibration data; and

the executing module includes:

a generating unit, configured to generate unlock information according to the matched preset eye tracking scenario and the eye movement information; and an unlocking unit, configured to determine, when it is detected that the generated unlock information is consistent with preset unlock information, that unlock is successful.

With reference to the second possible implementation manner of the second aspect, in a third possible implementation manner of the second aspect, the apparatus further includes:

an updating module, configured to update the eye tracking calibration data according to the acquired eye movement information and terminal status information.

With reference to the third possible implementation manner of the second aspect, in a fourth possible implementation manner of the second aspect, the updating module includes:

a historical data acquiring unit, configured to acquire historical login data that is closest to the time when the login unlock interface is displayed, where the historical login data includes historical eye movement information and historical terminal status information;

a determining unit, configured to determine whether the acquired eye movement information and terminal status information satisfy a change threshold of the historical login data;

a first updating unit, configured to update, when a determining result of the determining unit is yes, the eye tracking calibration data according to the acquired eye movement information and terminal status information; and

a second updating unit, configured to, when the determining result of the determining unit is no, acquire, from all eye tracking calibration data corresponding to the historical login data, eye tracking calibration data that matches the eye movement information and the terminal status information.

With reference to the second aspect and any one of the first to the fourth possible implementation manners of the second aspect, in a fifth possible implementation manner of the second aspect, the operation that corresponds to the eye movement information and is performed in the matched preset eye tracking scenario includes: inputting unlock information, selecting an element on a display page, or operating an application program.

A third aspect of an embodiment of the present invention provides a mobile terminal, and the mobile terminal includes:

a receiver, a transmitter, a memory, and a processor separately connected to the receiver, the transmitter, and the memory, where the memory stores a group of program code, and the processor is configured to invoke the program code stored in the memory and perform the following operations:

acquiring eye movement information and terminal status information;

matching a preset eye tracking scenario by using the acquired eye movement information and terminal status information; and

performing, in the matched preset eye tracking scenario, an operation corresponding to the eye movement information.

By implementing the embodiments of the present invention, eye movement information and terminal status information may be acquired; the acquired eye movement information and terminal status information are used to match a preset eye tracking scenario; and an operation corresponding to the eye movement information is performed in the matched preset eye tracking scenario. Therefore, eye tracking performed according to the eye movement information and the terminal status information is implemented, which increases the number of eye tracking dimensions, and improves precision of eye tracking and efficiency of eye movement-based interaction.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of an eye tracking method according to an embodiment of the present invention;

FIG. 2 is a schematic structural diagram of an eye tracking apparatus according to an embodiment of the present invention; and

FIG. 3 is a schematic structural diagram of a mobile terminal according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

The embodiments of the present invention provide an eye tracking method and apparatus. The apparatus in the embodiments of the present invention may include a mobile terminal having a camera, such as a smartphone, a tablet computer, or a smart watch, or may be implemented by using a client module in the mobile terminal having a camera, for example, an eye tracking client. An eye tracking solution provided by the embodiments of the present invention may be applied to unlocking of a mobile terminal, for example, a use scenario of an application program, such as an instant messaging application, a game application, an audio and video application, and a web browser, for example, browsing a web page by means of eye tracking, inputting unlock information by means of eye tracking, reading an e-book by means of eye tracking, and playing a game by means of eye tracking.

In the prior art, regardless of a status of a user and a mobile terminal, eye tracking is performed only according to the acquired eye movement data of the user, and a same eye tracking calibration model is used, so that precision of eye tracking is low. However, in the embodiments of the present invention, the eye tracking may be performed according to eye movement information and terminal status information; and eye tracking calibration is performed in real time according to real-time terminal status information, thereby improving precision of eye tracking The following gives a description by using specific embodiments.

FIG. 1 is a flowchart of an eye tracking method according to an embodiment of the present invention. The eye tracking method shown in FIG. 1 is described by using a mobile terminal as an execution body. As shown in the figure, a procedure in this embodiment includes steps S101 to S103.

S101. Acquire eye movement information and terminal status information.

S102. Match a preset eye tracking scenario by using the acquired eye movement information and terminal status information.

S103. Perform, in the matched preset eye tracking scenario, an operation corresponding to the eye movement information.

As an optional implementation manner, in step S101, the eye movement information and the terminal status information are acquired. Specifically, eye tracking calibration data may be acquired, and the eye movement information is acquired according to the eye tracking calibration data. The eye tracking calibration data is data in a preset eye tracking calibration model. The eye tracking calibration data in this embodiment of the present invention may be calibrated in real time according to the terminal status information and the eye movement information. The terminal status information may be obtained by detection performed by a built-in sensor of a mobile terminal or application software of the mobile terminal.

Further, optionally, the eye movement information includes but is not limited to a fixation point, a fixation time, a fixation count, a saccade distance, or a pupil size. Specifically, an eye movement has three basic manners: fixation (fixation), saccade (saccades), and pursuit movement (pursuit movement). A face image is acquired in real time by using a camera of the mobile terminal; an eye image is detected by using a face image recognition model; and then processing of gray value, marginalization, and so on is performed on the eye image, so as to acquire the eye movement information.

Further, optionally, the terminal status information includes but is not limited to environmental status information and terminal usage status information. The environmental status information includes but is not limited to light information, angular acceleration information, location information, or acceleration information. The terminal usage status information includes but is not limited to holding status information, communication information, user operation information, or application process information. Specifically, the environmental status information may be acquired by detection performed by a sensor in the mobile terminal, for example, brightness and intensity of light surrounding a mobile terminal may be detected by using an optical sensor; acceleration data of the terminal may be detected by using an acceleration sensor; angular acceleration data of the terminal may be detected by using an angular acceleration sensor; and location information of the mobile terminal may be detected by using a GPS (Global Positioning System, Global Positioning System) module. The terminal usage status information may be detected by using various application programs in the terminal; the holding status information, such as, one-handed holding/two-handed holding, may be determined by detecting a user's one-handed/two-handed operation on an operation interface; the communication information is an SMS message, a call, a contacts list opened by the user, or the like; the user operation information is a user's operation, such as touch or slide; and the application process information is various started application programs, application programs running in a background, application programs that are being operated by the user and run in a foreground, or the like.

As an optional implementation manner, in step S102, the acquired eye movement information and terminal status information are used to match the preset eye tracking scenario. In specific implementation, the acquired eye movement information and terminal status information are used to match the preset eye tracking scenario; each preset eye tracking scenario is corresponding to one eye tracking calibration model; eye tracking calibration data of each eye tracking calibration model is different; and the acquired current eye movement information and terminal status information are used to match the preset eye tracking scenario, so that a more precise eye tracking calibration model may be adopted. The preset eye tracking scenario is a combination of one or more of the following: a dark scenario, a bright scenario, a two-handed holding scenario, a one-handed holding scenario, a game scenario, a navigation scenario, a movement scenario, or a stationary scenario, and so on. Specifically, for example, when it is detected by using the optical sensor that the brightness of the light surrounding the terminal is less than a1 (a1 is greater than 0 cd/m²), and light intensity is less than b1 (b1 is greater than 0 cd), the dark scenario is matched; when it is detected by using the optical sensor that the brightness of the light surrounding the terminal is greater than a2, and the light intensity is greater than b2, the bright scenario is matched; when it is detected that a game application is running, and the user's operation is received in a game interface, the game scenario is matched; when it is detected that a speed of the mobile terminal is greater than 90 km/h, a car scenario is matched; when it is detected that the speed of the mobile terminal is greater than 5 km/h and less than 15 km/h, the movement scenario is matched; when it is detected that the speed of the mobile terminal is 0, the stationary scenario is matched; when it is detected that a map application and the GPS are started, the navigation scenario is matched, and so on.

As an optional implementation manner, in step S103, the operation corresponding to the eye movement information is performed in the matched preset eye tracking scenario. Specifically, the operation corresponding to the eye movement information is performed in the matched preset eye tracking scenario, and the eye movement information may be converted into an operation that is more appropriate for a current terminal status and current eye movement information, so that the operation corresponding to the eye movement information is performed more precisely. The operation corresponding to the eye movement information includes but is not limited to: inputting unlock information, selecting an element on a display page, or operating an application program, where the selecting an element on a display page is selecting a picture on a web page, selecting an option on a mobile phone setting page, or the like. The operation corresponding to the eye movement information is performed in the matched preset eye tracking scenario, for example, the mobile terminal is running the game application, and the matched preset eye tracking scenario is the game scenario plus the car scenario. A corresponding eye tracking calibration model is acquired according to the matched preset eye tracking scenario; then, a game is played by means of eye tracking that is performed according to the eye tracking calibration model. Specifically, the eye movement information is acquired according to the eye tracking calibration model, and then the eye movement information is converted into a corresponding game operation, where the game operation is leftward/rightward, upward/downward, or the like, so that the user plays the game by directly using eye movements without performing an operation on an interface with hands.

As an optional implementation manner, after the user starts the mobile terminal, the mobile terminal displays a login unlock interface. In this case, the mobile terminal acquires the eye tracking calibration data, acquires the eye movement information according to the eye tracking calibration data, and further acquires the terminal status information; matches the preset eye tracking scenario according to the acquired eye movement information and terminal status information; and generates the unlock information according to the matched preset eye tracking scenario and the eye movement information. If it is detected that the generated unlock information is consistent with preset unlock information, it is determined that unlock is successful; and if it is detected that the generated unlock information is inconsistent with the preset unlock information, the login unlock interface is returned, and the user is prompted to re-input information.

Further, optionally, for each time the login unlock interface is displayed, the unlock information may be input by using eye movements.

As an optional implementation manner, after step S103, the method may further include: updating the eye tracking calibration data according to the acquired eye movement information and terminal status information. In specific implementation, the updating the eye tracking calibration data according to the acquired eye movement information and terminal status information includes:

acquiring historical login data that is closest to the time when the login unlock interface is displayed, where the historical login data includes historical eye movement information and historical terminal status information;

determining whether the acquired eye movement information and terminal status information satisfy a change threshold of the historical login data;

if the acquired eye movement information and terminal status information satisfy the change threshold of the historical login data, updating the eye tracking calibration data according to the acquired eye movement information and terminal status information; and if the acquired eye movement information and terminal status information do not satisfy the change threshold of the historical login data, acquiring, from all eye tracking calibration data corresponding to the historical login data, eye tracking calibration data that matches the eye movement information and the terminal status information.

Specifically, the historical login data may include historical eye movement information and historical terminal status information; the historical terminal status information includes historical environmental status information and historical terminal usage status information, where the historical environmental status information includes but is not limited to light information, angular acceleration information, location information, or acceleration information, and the historical terminal usage status information includes but is not limited to holding status information, communication information, user operation information, or application process information. The change threshold of the historical login data, for example, a change threshold of brightness of light is ±a0 (for example, a0=10 cd/m²); a change threshold of light intensity is ±b0 (for example, b0=5 cd); a change threshold of a speed of a mobile terminal is ±c0 (the speed of the mobile terminal is greater than 0, for example, c0 32 0.05 km/h); a change threshold of a fixation count is ±d0 (for example, d0=3 times); and a change threshold of a fixation time is ±f0 (for example, f0=3 ms).

After it is determined that unlock is successful, the historical login data of previous login may be acquired, and then eye movement information and terminal status information acquired this time are compared with the historical login data, so as to determine whether the eye movement information and the terminal status information acquired this time satisfy the change threshold of the historical login data. If the eye movement information and the terminal status information acquired this time satisfy the change threshold of the historical login data, the eye tracking calibration data is updated according to the eye movement information and the terminal status information acquired this time; if the eye movement information and the terminal status information acquired this time do not satisfy the change threshold of the historical login data, the eye tracking calibration data that matches the eye movement information and the terminal status information is acquired from all the eye tracking calibration data corresponding to the historical login data; and the eye tracking calibration data is updated according to the eye tracking calibration data acquired from the eye tracking calibration data corresponding to the historical login data. For example, previous login to an unlock interface and performing unlock successfully were 10 minutes ago, and a corresponding preset eye tracking scenario is a dark scenario plus a two-handed holding scenario; when the unlock interface is logged in to this time, a corresponding preset eye tracking scenario is a dark scenario plus a one-handed holding scenario. Each preset eye tracking scenario is corresponding to one eye tracking calibration model; eye tracking calibration data in each eye tracking calibration model is different; data of previous login and that of login this time are different and do not satisfy the change threshold of the historical login data. Therefore, an eye tracking calibration model that is consistent with the eye tracking calibration model corresponding to the preset eye tracking scenario of a login unlock interface this time is found from all the eye tracking calibration models corresponding to the historical login data, and is determined as a target update calibration model this time, and the target update calibration model is used as an eye tracking calibration model for a next login operation.

Further, optionally, in a process in which the user uses the mobile terminal, the eye movement information and the terminal status information may be acquired in real time, and then the eye tracking calibration data is updated in real time according to the acquired eye movement information and terminal status information. Therefore, the eye tracking calibration data corresponding to the preset eye tracking scenario is more precise, and a more precise calibration model is provided for a next operation scenario, so as to perform an operation corresponding to the eye movement information more precisely.

As an optional implementation manner, for example, in a login unlock interface, a user sequentially selects, by tapping, a preset 9-character password (for example, “914728653”) by using a line of sight on a 3×3 numeric/alphabetic keyboard displayed on a display screen of a mobile terminal. Meanwhile, positioning of the line of sight in 9 areas is acquired, and terminal status information is acquired. The user is currently standing on a bus in motion, and the display screen tilts 45 degrees in a vertical direction. According to the acquired eye movement information and terminal status information, a preset eye tracking scenario, that is, a car scenario is matched. It is detected that the user starts a browser application, and in this case, the user can control and browse a web page by using eye movements. If the user sits on an empty seat, it may be detected that a vertical tilt angle of the display screen is 20 degrees, the preset eye tracking scenario continues to be adjusted according to the terminal status information, so as to ensure accuracy of a position linked by the user's tapping by using eye movements.

As an optional implementation manner, for example, a user is currently sitting under sufficient light in a room, and places hands on a desk; a screen and a line of sight are basically at a same level. A mobile terminal may detect by using an optical sensor that brightness of light surrounding a terminal is greater than a2 and light intensity is greater than b2, and a bright scenario is matched. The mobile terminal displays an unlock interface, and the unlock interface includes 9 preset areas. Eye movement information is acquired, and the eye movement information includes a track of the user's line of sight. Specifically, the user's line of sight moves among the 9 preset areas; the track of the user's line of sight may form a pattern, for example, a saw tooth, and the pattern is the unlock information; eye tracking calibration is performed according to the eye movement information and terminal status information, and the current eye tracking calibration is set as a model 1. After unlock is successful, the user enters a main interface of the mobile terminal, and starts a game application program. The user can play the game by using eye movements. If the user turns on a desk lamp in the room, the mobile terminal detects that the brightness of the light surrounding the terminal and the light intensity change. The eye tracking calibration is performed according to current terminal status information, and the eye tracking calibration is set as a model 2, and a comparison is made between the model 1 and the model 2. If the model 2 satisfies a parameter change threshold of the model 1, the model 1 continues to be used for calibration; and if the model 2 does not satisfy the parameter change threshold of the model 1, the model 2 is used for calibration.

As an optional implementation manner, for example, a user walks in a relatively dark outdoor place and a line of sight is nearly vertical to a screen held by hands. A mobile terminal may detect by using an optical sensor that brightness of light surrounding a terminal is less than a1 and light intensity is less than b1, and a dark scenario is matched. The mobile terminal displays an unlock interface, and the unlock interface includes 12 patterns. Eye movement information is acquired, and the eye movement information includes a track of the user's line of sight or positioning of the user's line of sight. Specifically, the user needs to position 9 preset patterns among the 12 patterns by using the line of sight, and an order of positioning 9 preset patterns by using the line of sight or the 9 preset patterns positioned by using the line of sight is used as the unlock information. Eye tracking calibration is performed according to the eye movement information and terminal status information, and current eye tracking calibration is set as a model 3. After unlock is successful, the user enters a main interface of the mobile terminal, and starts a map navigation application program. The user can perform positioning and navigation on a map by using eye movements. The user walks in a corridor, and a movement scenario plus a dark scenario is matched; the user stops to search for a direction at branch junctions of the corridor, and in this case, a stationary scenario plus a dark scenario is matched, displacement compensation required for eye tracking becomes small.

In an eye tracking method provided by this embodiment of the present invention, eye movement information and terminal status information may be acquired; the acquired eye movement information and terminal status information are used to match a preset eye tracking scenario; and an operation corresponding to the eye movement information is performed in the matched preset eye tracking scenario, which implements eye tracking performed according to the eye movement information and the terminal status information, so that the eye movement information and the terminal status information may be acquired in real time, and eye tracking calibration data is updated in real time according to the acquired eye movement information and terminal status information. Therefore, eye tracking calibration data corresponding to the preset eye tracking scenario is more precise and a more precise calibration model is provided for a next operation scenario, so that the operation corresponding to the eye movement information is performed more precisely, which increases the number of eye tracking dimensions, and improves precision of eye tracking and efficiency of eye movement-based interaction.

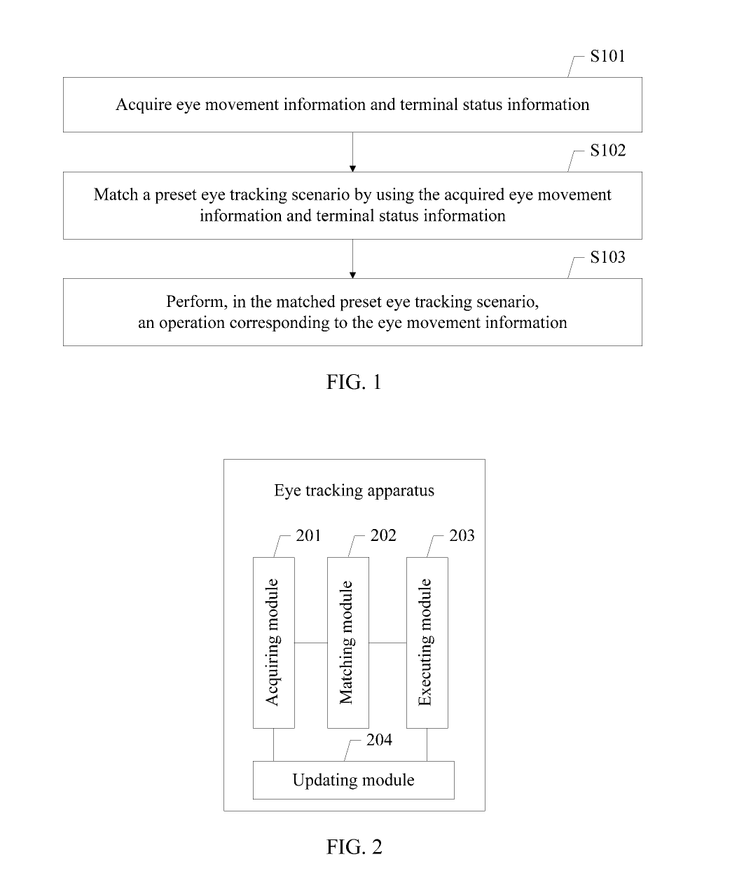

The following describes in detail an eye tracking apparatus provided by this embodiment of the present invention with reference to FIG. 2.

It should be noted that, the eye tracking apparatus shown in FIG. 2 is used to perform a method in an embodiment shown in FIG. 1 of the present invention, and is an execution body based on the eye tracking method shown in FIG. 1. For ease of description, only a part related to this embodiment of the present invention is shown. For specific technical details that are not disclosed, refer to the embodiment shown in FIG. 1 of the present invention.

FIG. 2 is a schematic structural diagram of the eye tracking apparatus provided by this embodiment of the present invention. The eye tracking apparatus provided by this embodiment of the present invention may include: an acquiring module 201, a matching module 202, and an executing module 203.

The acquiring module 201 is configured to acquire eye movement information and terminal status information.

The matching module 202 is configured to match a preset eye tracking scenario by using the eye movement information and the terminal status information that are acquired by the acquiring module.

The executing module 203 is configured to perform, in the matched preset eye tracking scenario, an operation corresponding to the eye movement information.

As an optional implementation manner, the acquiring module 201 acquires the eye movement information and the terminal status information. Specifically, eye tracking calibration data may be acquired, and the eye movement information is acquired according to the eye tracking calibration data. The eye tracking calibration data is data in a preset eye tracking calibration model. The eye tracking calibration data in this embodiment of the present invention may be calibrated in real time according to the terminal status information and the eye movement information. The terminal status information may be obtained by detection performed by a built-in sensor of a mobile terminal or application software of the mobile terminal.

Further, optionally, the eye movement information includes but is not limited to a fixation point, a fixation time, a fixation count, a saccade distance, or a pupil size. Specifically, an eye movement has three basic manners: fixation, saccade, and pursuit movement. A face image is acquired in real time by using a camera of the mobile terminal; an eye image is detected by using a face image recognition model; and then processing of gray value, marginalization, and so on is performed on the eye image, so as to acquire the eye movement information.

Further, optionally, the terminal status information includes but is not limited to environmental status information and terminal usage status information. The environmental status information includes but is not limited to light information, angular acceleration information, location information, or acceleration information. The terminal usage status information includes but is not limited to holding status information, communication information, user operation information, or application process information. Specifically, the environmental status information may be acquired by detection performed by a sensor in the mobile terminal, for example, brightness and intensity of light surrounding a terminal may be detected by using an optical sensor; acceleration data of the terminal may be detected by using an acceleration sensor; angular acceleration data of the terminal may be detected by using an angular acceleration sensor; and location information of the mobile terminal may be detected by using a GPS module. The terminal usage status information may be detected by using various application programs in the terminal; the holding status information, such as, one-handed holding/two-handed holding, may be determined by detecting a user's one-handed/two-handed operation on an operation interface; the communication information is an SMS message, a call, a contacts list opened by the user, or the like; the user operation information is the user's operation such as touch or slide; and the application process information is various started application programs, application programs running in a background, application programs that are being operated by the user and run in a foreground, or the like.

As an optional implementation manner, the matching module 202 uses the acquired eye movement information and terminal status information to match the preset eye tracking scenario. In specific implementation, the acquired eye movement information and terminal status information are used to match the preset eye tracking scenario; each preset eye tracking scenario is corresponding to one eye tracking calibration model; eye tracking calibration data of each eye tracking calibration model is different; and the acquired current eye movement information and terminal status information are used to match the preset eye tracking scenario, so that a more precise eye tracking calibration model may be adopted. The preset eye tracking scenario is a combination of one or more of the following: a dark scenario, a bright scenario, a two-handed holding scenario, a one-handed holding scenario, a game scenario, a navigation scenario, a movement scenario, or a stationary scenario, and so on. Specifically, for example, when it is detected by using the optical sensor that the brightness of the light surrounding the terminal is less than a1 (a1 is greater than 0 cd/m²), and light intensity is less than b1 (b1 is greater than 0 cd), a dark scenario is matched; when it is detected by using the optical sensor that the brightness of the light surrounding the terminal is greater than a2, and the light intensity is greater than b2, the bright scenario is matched; when it is detected that a game application is running, and the user's operation is received in a game interface, the game scenario is matched; when it is detected that a speed of the mobile terminal is greater than 90 km/h, a car scenario is matched; when it is detected that the speed of the mobile terminal is greater than 5 km/h and less than 15 km/h, the movement scenario is matched; when it is detected that the speed of the mobile terminal is 0, the stationary scenario is matched; when it is detected that a map application and the GPS are started, the navigation scenario is matched, and so on.

As an optional implementation manner, the executing module 203 performs, in the matched preset eye tracking scenario, the operation corresponding to the eye movement information. Specifically, the operation corresponding to the eye movement information is performed in the matched preset eye tracking scenario, and the eye movement information may be converted into an operation that is more appropriate for a current terminal status and current eye movement information, so that the operation corresponding to the eye movement information is performed more precisely. The operation corresponding to the eye movement information includes but is not limited to: inputting unlock information, selecting an element on a display page, or operating an application program, where the selecting an element on a display page is selecting a picture on a web page, selecting an option on a mobile phone setting page, or the like. The operation corresponding to the eye movement information is performed in the matched preset eye tracking scenario, for example, the mobile terminal is running a game application, and the matched preset eye tracking scenario is the game scenario plus the car scenario. A corresponding eye tracking calibration model is acquired according to the matched preset eye tracking scenario; then, a game is played by means of eye tracking that is performed according to the eye tracking calibration model. Specifically, the eye movement information is acquired according to the eye tracking calibration model, and then the eye movement information is converted into a corresponding game operation, where the game operation is leftward/rightward, upward/downward, or the like, so that the user plays the game by directly using eye movements without performing an operation on an interface with hands.

As an optional implementation manner, the acquiring module 201 is further specifically configured to:

acquire eye tracking calibration data when a login unlock interface is displayed, and acquire the eye movement information according to the eye tracking calibration data.

Further, optionally, the executing module 203 may include: a generating unit and an unlocking unit.

The generating unit is configured to generate unlock information according to the matched preset eye tracking scenario and the eye movement information.

The unlocking unit is configured to determine, when it is detected that the generated unlock information is consistent with preset unlock information, that unlock is successful.

Specifically, after the user starts the mobile terminal, the mobile terminal displays a login unlock interface. In this case, the mobile terminal acquires the eye tracking calibration data, acquires the eye movement information according to the eye tracking calibration data, and further acquires the terminal status information; matches the preset eye tracking scenario according to the acquired eye movement information and terminal status information; and the generating unit generates the unlock information according to the matched preset eye tracking scenario and the eye movement information. If it is detected that the generated unlock information is consistent with preset unlock information, the unlocking unit determines that unlock is successful; and if it is detected that the generated unlock information is inconsistent with the preset unlock information, the login unlock interface is returned, and the user is prompted to re-input information.

Further, optionally, for each time the login unlock interface is displayed, the unlock information may be input by using eye movements.

Further, optionally, the eye tracking apparatus provided by this embodiment of the present invention further includes an updating module 204.

The updating module 204 is configured to update the eye tracking calibration data according to the acquired eye movement information and terminal status information. The updating module 204 may include a historical data acquiring unit, a determining unit, a first updating unit, and a second updating unit.

The historical data acquiring unit is configured to acquire historical login data that is closest to the time when the login unlock interface is displayed, where the historical login data includes historical eye movement information and historical terminal status information.

The determining unit is configured to determine whether the acquired eye movement information and terminal status information satisfy a change threshold of the historical login data.

The first updating unit is configured to update, when a determining result of the determining unit is yes, the eye tracking calibration data according to the acquired eye movement information and terminal status information.

The second updating unit is configured to, when the determining result of the determining unit is no, acquire, from all eye tracking calibration data corresponding to the historical login data, eye tracking calibration data that matches the eye movement information and the terminal status information.

Specifically, the historical login data may include historical eye movement information and historical terminal status information. The historical terminal status information includes historical environmental status information and historical terminal usage status information, where the historical environmental status information includes but is not limited to light information, angular acceleration information, location information, or acceleration information, and the historical terminal usage status information includes but is not limited to holding status information, communication information, user operation information, or application process information. The change threshold of the historical login data, for example, a change threshold of brightness of light is ±a0 (for example, a0=10 cd/m²); a change threshold of light intensity is ±b0 (for example, b0=5 cd); a change threshold of a speed of a mobile terminal is ±c0 (the speed of the mobile terminal is greater than 0, for example, c0=0.05 km/h); a change threshold of a fixation count is ±d0 (for example, d0=3 times); and a change threshold of a fixation time is ±f0 (for example, f0=30 ms).

After it is determined that unlock is successful, the historical login data of previous login may be acquired, and then eye movement information and terminal status information acquired this time are compared with the historical login data, so as to determine whether the eye movement information and the terminal status information acquired this time satisfy the change threshold of the historical login data. If the eye movement information and the terminal status information acquired this time satisfy the change threshold of the historical login data, the eye tracking calibration data is updated according to the eye movement information and the terminal status information acquired this time; if the eye movement information and the terminal status information acquired this time do not satisfy the change threshold of the historical login data, the eye tracking calibration data that matches the eye movement information and the terminal status information is acquired from all the eye tracking calibration data corresponding to the historical login data; and the eye tracking calibration data acquired from the eye tracking calibration data corresponding to the historical login data is used for updating. For example, previous login to an unlock interface and performing unlock successfully were 10 minutes ago, and a corresponding preset eye tracking scenario is a dark scenario plus a two-handed holding scenario; when the unlock interface is logged in to this time, a corresponding preset eye tracking scenario is a dark scenario plus a one-handed holding scenario. Each preset eye tracking scenario is corresponding to one eye tracking calibration model; eye tracking calibration data in each eye tracking calibration model is different; data of previous login and that of login this time are different and do not satisfy the change threshold of the historical login data. Therefore, an eye tracking calibration model that is consistent with the eye tracking calibration model corresponding to the preset eye tracking scenario of a login unlock interface this time is found from all the eye tracking calibration models corresponding to the historical login data, and is determined as a target update calibration model this time, and the target update calibration model is used as an eye tracking calibration model for a next login operation.

Further, optionally, in a process in which the user uses the mobile terminal, the eye movement information and the terminal status information may be acquired in real time, and then the eye tracking calibration data is updated in real time according to the acquired eye movement information and terminal status information. Therefore, the eye tracking calibration data corresponding to the preset eye tracking scenario is more precise, and a more precise calibration model is provided for a next operation scenario, so as to perform an operation corresponding to the eye movement information more precisely.

As an optional implementation manner, for example, in a login unlock interface, a user sequentially selects, by tapping, a preset 9-character password (for example, “914728653”) by using a line of sight on a 3×3 numeric/alphabetic keyboard displayed on a display screen of a mobile terminal. Meanwhile, positioning of the line of sight in 9 areas is acquired, and terminal status information is acquired. The user is currently standing on a bus in motion, and the display screen tilts 45 degrees in a vertical direction. According to the acquired eye movement information and terminal status information, a preset eye tracking scenario, that is, a car scenario is matched. It is detected that the user starts a browser application, and in this case, the user can control and browse a web page by using eye movements. If the user sits on an empty seat, it may be detected that a vertical tilt angle of the display screen is 20 degrees, the preset eye tracking scenario continues to be adjusted according to the terminal status information, so as to ensure accuracy of a position linked by the user's tapping by using eye movements.

As an optional implementation manner, for example, a user is currently sitting under sufficient light in a room, and places hands on a desk; a screen and a line of sight are basically at a same level. A mobile terminal may detect by using an optical sensor that brightness of light surrounding a terminal is greater than a2 and light intensity is greater than b2, and a bright scenario is matched. The mobile terminal displays an unlock interface, and the unlock interface includes 9 preset areas. Eye movement information is acquired, and the eye movement information includes a track of the user's line of sight. Specifically, the user's line of sight moves among the 9 preset areas; the track of the user's line of sight may form a pattern, for example, a saw tooth, and the pattern is the unlock information; eye tracking calibration is performed according to the eye movement information and terminal status information, and the current eye tracking calibration is set as a model 1. After unlock is successful, the user enters a main interface of the mobile terminal, and starts a game application program. The user can play the game by using eye movements. If the user turns on a desk lamp in the room, the mobile terminal detects that the brightness of the light surrounding the terminal and the light intensity change. The eye tracking calibration is performed according to current terminal status information, and the eye tracking calibration is set as a model 2, and a comparison is made between the model 1 and the model 2. If the model 2 satisfies a parameter change threshold of the model 1, the model 1 continues to be used for calibration; and if the model 2 does not satisfy the parameter change threshold of the model 1, the model 2 is used for calibration.

As an optional implementation manner, for example, a user walks in a relatively dark outdoor place and a line of sight is nearly vertical to a screen held by hands. A mobile terminal may detect by using an optical sensor that brightness of light surrounding a terminal is less than a1 and light intensity is less than b1, and a dark scenario is matched. The mobile terminal displays an unlock interface, and the unlock interface includes 12 patterns. Eye movement information is acquired, and the eye movement information includes a track of the user's line of sight or positioning of the user's line of sight. Specifically, the user needs to position 9 preset objects among the 12 patterns by using the line of sight, and an order of positioning 9 preset patterns by using the line of sight or the 9 preset patterns positioned by using the line of sight is used as the unlock information. Eye tracking calibration is performed according to the eye movement information and terminal status information, and current eye tracking calibration is set as a model 3. After unlock is successful, the user enters a main interface of the mobile terminal, and starts a map navigation application program. The user can perform positioning and navigation on a map by using eye movements. The user walks in a corridor, and a movement scenario plus a dark scenario is matched; the user stops to search for a direction at branch junctions of the corridor, and in this case, a stationary scenario plus a dark scenario is matched, displacement compensation required for eye tracking becomes small.

In an eye tracking apparatus provided by this embodiment of the present invention, an acquiring module may acquire eye movement information and terminal status information; a matching module may match a preset eye tracking scenario by using the acquired eye movement information and terminal status information; and an executing module may perform, in the matched preset eye tracking scenario, an operation corresponding to the eye movement information, which implements eye tracking performed according to the eye movement information and the terminal status information, so that the eye movement information and the terminal status information may be acquired in real time, and eye tracking calibration data is updated in real time according to the acquired eye movement information and terminal status information. Therefore, eye tracking calibration data corresponding to the preset eye tracking scenario is more precise and a more precise calibration model is provided for a next operation scenario, so that the operation corresponding to the eye movement information is performed more precisely, which increases the number of eye tracking dimensions, and improves precision of eye tracking and efficiency of eye movement-based interaction.

It should be noted that, the acquiring module, the matching module, and the executing module in this embodiment may be an independently disposed processor; or may be integrated into a processor of the mobile terminal for implementation. In addition, the acquiring module, the matching module, and the executing module may also be stored in a memory of the mobile terminal in a form of program code, and a function of the foregoing status information acquiring module is invoked and performed by a processor of the mobile terminal. Implementation of the updating module is the same as that of the acquiring module, the matching module, and the executing module. The updating module may be integrated with the acquiring module, the matching module, and the executing module, or may be independently implemented. The processor described herein may be a central processing unit (Central Processing Unit, CPU), or an application specific integrated circuit (Application Specific Integrated Circuit, ASIC), or may be configured as one or more integrated circuits that implement this embodiment of the present invention.

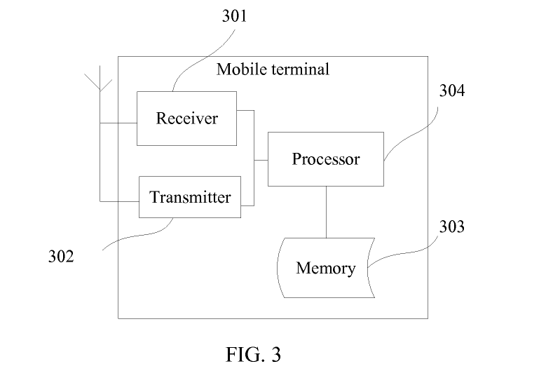

Referring to FIG. 3, FIG. 3 is a schematic structural diagram of a mobile terminal according to an embodiment of the present invention. The mobile terminal provided by this embodiment is corresponding to a method shown in FIG. 1, and is an execution body based on an eye tracking method shown in FIG. 1. FIG. 3 shows a specific implementation manner. The mobile terminal in this embodiment of the present invention includes a receiver 301, a transmitter 302, a memory 303, and a processor 304, where the receiver 301, the transmitter 302, and the memory 303 are all connected to the processor 304, for example, may be connected by using a bus. Certainly, a network element device may further include general components such as an antenna, a baseband processing component, an intermediate frequency and radio frequency processing component, and an input and output apparatus, which is not limited by this embodiment of the present invention.

The receiver 301 and the transmitter 302 may be integrated to form a transceiver.

The memory 303 is configured to store executable program code, where the program code includes computer operation instructions. The memory 303 may include a high-speed RAM memory, and may further include a non-volatile memory (non-volatile memory), for example, at least one disk memory.

The processor 304 may be a central processing unit, or an application specific integrated circuit, or may be configured as one or more integrated circuits that implement this embodiment of the present invention.

The memory 303 stores a group of program code, and the processor 304 is configured to invoke the program code stored in the memory 303, and perform the following operations:

acquiring eye movement information and terminal status information;

matching a preset eye tracking scenario by using the acquired eye movement information and terminal status information; and performing, in the matched preset eye tracking scenario, an operation corresponding to the eye movement information.

As an optional implementation manner, the terminal status information includes: environmental status information and terminal usage status information.

The environmental status information includes: light information, angular acceleration information, location information, or acceleration information.

The terminal usage status information includes: holding status information, communication information, user operation information, or application process information.

As an optional implementation manner, the acquiring, by the processor 304, eye movement information and terminal status information includes:

acquiring eye tracking calibration data when a login unlock interface is displayed, and acquiring the eye movement information according to the eye tracking calibration data; and

the performing, in the matched preset eye tracking scenario, an operation corresponding to the eye movement information includes:

generating unlock information according to the matched preset eye tracking scenario and the eye movement information; and

determining, if it is detected that the generated unlock information is consistent with preset unlock information, that unlock is successful.

As an optional implementation manner, after the performing, in the matched preset eye tracking scenario, an operation corresponding to the eye movement information, the processor 304 is further configured to:

update the eye tracking calibration data according to the acquired eye movement information and terminal status information.

As an optional implementation manner, the updating, by the processor 304, the eye tracking calibration data according to the acquired eye movement information and terminal status information includes:

acquiring historical login data that is closest to the time when the login unlock interface is displayed, where the historical login data includes historical eye movement information and historical terminal status information;

determining whether the acquired eye movement information and terminal status information satisfy a change threshold of the historical login data;

if the acquired eye movement information and terminal status information satisfy the change threshold of the historical login data, updating the eye tracking calibration data according to the acquired eye movement information and terminal status information; and if the acquired eye movement information and terminal status information do not satisfy the change threshold of the historical login data, acquiring, from all eye tracking calibration data corresponding to the historical login data, eye tracking calibration data that matches the eye movement information and the terminal status information.

As an optional implementation manner, the operation that corresponds to the eye movement information and is performed by the processor 304 in the matched preset eye tracking scenario includes: inputting unlock information, selecting an element on a display page, or operating an application program.

In the foregoing technical solutions, a mobile terminal is provided and includes: a receiver, a transmitter, a memory, and a processor. The processor may acquire eye movement information and terminal status information; match a preset eye tracking scenario by using the acquired eye movement information and terminal status information; and perform an operation corresponding to the eye movement information in the matched preset eye tracking scenario, which implements eye tracking performed according to the eye movement information and the terminal status information. Therefore, the eye movement information and the terminal status information may be acquired in real time, and eye tracking calibration data is updated in real time according to the acquired eye movement information and terminal status information. Therefore, eye tracking calibration data corresponding to the preset eye tracking scenario is more precise and a more precise calibration model is provided for a next operation scenario, so that the operation corresponding to the eye movement information is performed more precisely, which increases the number of eye tracking dimensions, and improves precision of eye tracking and efficiency of eye movement-based interaction.

In the several embodiments provided in the present application, it should be understood that the disclosed apparatus and method may be implemented in other manners. For example, the described apparatus embodiment is merely exemplary. For example, the module or unit division is merely logical function division and may be other division in actual implementation. For example, a plurality of units or modules may be combined or integrated into another system, or some features may be ignored or not performed. In addition, the displayed or discussed mutual couplings or direct couplings or communication connections may be implemented through some interfaces. The indirect couplings or communication connections between the apparatuses, modules, or units may be implemented in electronic, mechanical, or other forms.

The modules or units described as separate parts may or may not be physically separate, and parts displayed as modules or units may or may not be physical modules or units, may be located in one position, or may be distributed on a plurality of network modules or units. A part or all of the modules or units may be selected according to actual needs to achieve the purposes of the solutions of the embodiments of the present application.

In addition, functional modules or units in the embodiments of the present application may be integrated into one processing module or unit, or each of the modules or units may exist alone physically, or two or more modules or units are integrated into one module or unit. The integrated modules or units may be implemented in a form of hardware, or may be implemented in a form of a software functional unit.

When the integrated module or unit is implemented in the form of a software functional module or unit and sold or used as an independent product, the integrated module or unit may be stored in a computer-readable storage medium. Based on such an understanding, the technical solutions of the present application essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present application. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific embodiments of the present application, but are not intended to limit the protection scope of the present application. Any modification or replacement readily figured out by a person skilled in the art within the technical scope disclosed in the present application shall fall within the protection scope of the present application. Therefore, the protection scope of the present application shall be subject to the protection scope of the claims.

1. An eye tracking method, the method comprising:
acquiring eye movement information and terminal status information;
matching a preset eye tracking scenario using the acquired eye movement information and terminal status information; and
performing, in the matched preset eye tracking scenario, an operation corresponding to the eye movement information.

2. The method according to claim 1, wherein the terminal status information comprises: environmental status information and terminal usage status information;
the environmental status information comprises: light information, angular acceleration information, location information, or acceleration information; and
the terminal usage status information comprises: holding status information, communication information, user operation information, or application process information.

3. The method according to claim 1, wherein the acquiring eye movement information and terminal status information comprises:
acquiring eye tracking calibration data when a login unlock interface is displayed, and acquiring the eye movement information according to the eye tracking calibration data; and
the performing, in the matched preset eye tracking scenario, an operation corresponding to the eye movement information comprises:
generating unlock information according to the matched preset eye tracking scenario and the eye movement information, wherein if it is detected that the generated unlock information is consistent with preset unlock information, that unlock is successful.

4. The method according to claim 3, the method further comprising:
updating the eye tracking calibration data according to the acquired eye movement information and terminal status information.

5. The method according to claim 4, wherein the updating the eye tracking calibration data according to the acquired eye movement information and terminal status information comprises:
acquiring historical login data that is closest to the a time when the login unlock interface is displayed, wherein the historical login data comprises historical eye movement information and historical terminal status information;
determining whether the acquired eye movement information and terminal status information satisfy a change threshold of the historical login data;
if the acquired eye movement information and terminal status information satisfy the change threshold of the historical login data, updating the eye tracking calibration data according to the acquired eye movement information and terminal status information; and
if the acquired eye movement information and terminal status information do not satisfy the change threshold of the historical login data, acquiring, from all eye tracking calibration data corresponding to the historical login data, eye tracking calibration data that matches the eye movement information and the terminal status information.

6. The method according to claim 1, wherein the operation that corresponds to the eye movement information and is performed in the matched preset eye tracking scenario comprises: inputting unlock information, selecting an element on a display page, or operating an application program.

7. An eye tracking apparatus, the apparatus comprising a processor and a non-transitory processor-readable medium having processor-executable instructions stored thereon, the processor-executable instructions including a plurality of modules, the modules including:
an acquiring module, configured to acquire eye movement information and terminal status information;
a matching module, configured to match a preset eye tracking scenario using the eye movement information and the terminal status information that are acquired by the acquiring module; and
an executing module, configured to perform, in the matched preset eye tracking scenario, an operation corresponding to the eye movement information.

8. The apparatus according to claim 7, wherein the terminal status information comprises: environmental status information and terminal usage status information;
the environmental status information comprises: light information, angular acceleration information, location information, or acceleration information; and
the terminal usage status information comprises: holding status information, communication information, user operation information, or application process information.

9. The apparatus according to claim 7, wherein the acquiring module is configured to acquire eye movement information and terminal status information, wherein acquire eye tracking calibration data when a login unlock interface is displayed, and acquire the eye movement information according to the eye tracking calibration data; and
the executing module comprises:
a generating unit, configured to generate unlock information according to the matched preset eye tracking scenario and the eye movement information; and
an unlocking unit, configured to determine, when the generated unlock information is consistent with preset unlock information, that unlock is successful.

10. The apparatus according to claim 9, wherein the apparatus further comprises:
an updating module, configured to update the eye tracking calibration data according to the acquired eye movement information and terminal status information.

11. The apparatus according to claim 10, wherein the updating module comprises:
a historical data acquiring unit, configured to acquire historical login data that is closest to a time when the login unlock interface is displayed, wherein the historical login data comprises historical eye movement information and historical terminal status information;
a determining unit, configured to determine whether the acquired eye movement information and terminal status information satisfy a change threshold of the historical login data;
a first updating unit, configured to update, when a determining result of the determining unit is that the acquired eye movement information and terminal status information satisfy a change threshold of the historical login data, the eye tracking calibration data according to the acquired eye movement information and terminal status information; and
a second updating unit, configured to, when the determining result of the determining unit is that the acquired eye movement information and terminal status information do not satisfy a change threshold of the historical login data, acquire, from all eye tracking calibration data corresponding to the historical login data, eye tracking calibration data that matches the eye movement information and the terminal status information.

12. The apparatus according to claim 7, wherein the operation that corresponds to the eye movement information and is performed in the matched preset eye tracking scenario comprises: inputting unlock information, selecting an element on a display page, or operating an application program.
